(19) United States
(12) Patent Application Publication
(10) Pub. No.: US 2019/0062616 A1
(43) Pub. Date: Feb. 28, 2019

(54) METHOD FOR PROVIDING ZONAL ISOLATION IN AN UNDERGROUND WELLBORE

(71) Applicant: SHELL OIL COMPANY, HOUSTON, TX (US)

(72) Inventors: Erik Kerst CORNELISSEN, Rijswijk (NL); Jan Hermen Hendrik MEURS, Amsterdam (NL); Josje Malu OVERBEEK, Rijswijk (NL); Frank RUCKERT, Rijswijk (NL); Gerbrand Jozef Maria VAN EIJDEN, Rijswijk (NL)

(21) Appl. No.: 16/075,927

(22) PCT Filed: Feb. 6, 2017
(86) PCT No.: PCT/EP2017/052539

§ 371 Date: Aug. 6, 2018

(30) Foreign Application Priority Data
Feb. 8, 2016 (EP) 16154699.9

(51) Int. Cl. C09K 8/44; C09K 8/46; C04B 26/32; C04B 26/06; C04B 24/00; C04B 24/12; E21B 33/13; E21B 33/14

(52) U.S. Cl. CPC C09K 8/44; C09K 8/46; C04B 26/32; C04B 26/06; C04B 2103/0062; C04B 24/12; E21B 33/13; E21B 33/14; C04B 24/005

(57) ABSTRACT

Slugs of a cement slurry and of a resin composition are injected into an underground wellbore. The resin composition contains at least a curable resin, a filler, a swelling agent, a curing initiator, and a crosslinking retarding agent. The curing initiator activates the curing in response to temperature. The crosslinking retarding agent delays curing of the resin, to permit pumping the composition into the wellbore. After injection, the cement slurry and resin composition are allowed to cure, to create a stacked cement and cured resin column that provides a zonal isolation seal within the wellbore. The resin composition may suitably be an elastomer-forming composition. The cured resin may be swellable by allowing contact with a wellbore fluid.

### FIELD

The invention relates to a method for providing zonal isolation in an underground wellbore.

### BACKGROUND

Currently Portland based cement systems are generally used for zonal isolation in oil and/or gas production wells. Cement is a brittle material by default and can easily crack if it gets deformed by external and internal stress loads. This causes the formation of micro-annuli and/or cracks resulting in leak paths. Pressure communication to surface behind casing due to micro annuli or cracked cement has been recognized as a major problem in the oil and gas industry. Worldwide some 30% of the well stock has some form of pressure problems at surface.

The application of both oil and water swell packers have proven to be a cost effective solution for numerous zonal isolation applications in oil and gas wells. The combination of oil well cement with swell packers to mitigate micro-annuli and placement issues has been successful as well. Swell packers however reduce the running clearance of casing and pipes. Additionally in wash-out zones the swell may be not enough to close of the annulus.

WO 2015/153286 A1 discloses a cement for use in wells, which comprises polymer particles. In the event of cement-matrix failure, or bonding failure between the cement/casing interface or the cement/borehole-wall interface, the polymer particles swell when contacted by hydrogen sulfide. The swelling seals voids in the cement matrix, or along the bonding interfaces, and thereby restores zonal isolation.

The known methods and systems have different limitations that make them unsuitable for downhole zonal isolation in underground wellbores at elevated temperatures and pressures.

### SUMMARY OF THE INVENTION

In accordance with the invention there is provided a method for providing zonal isolation in an underground wellbore, the method comprising:
injecting into the wellbore slugs of a cement slurry and of a resin composition comprising a curable resin, a filler, a swelling agent, a curing initiator and a crosslinking retarding agent, which delays curing of the resin to permit pumping the composition into the wellbore; and
allowing the cement slurry and resin composition to cure to create a stacked cement and cured resin column that provides a zonal isolation seal within the wellbore.

These and other features, embodiments and advantages of the zonal isolation method according to the invention are described in the accompanying claims, abstract and the following detailed description of non-limiting embodiments depicted in the accompanying drawings, in which description reference numerals are used which refer to corresponding reference numerals that are depicted in the drawings.

### BRIEF DESCRIPTION OF THE DRAWINGS

FIG. 1 schematically shows a stacked annular cement and resin column in a wellbore within an annular space surrounding a wellbore tubular;

FIG. 2 schematically shows a stacked annular cement and resin column in a wellbore to seal off at least a lower part of the wellbore;

FIG. 3 shows the effect of curing inhibitor TEMPO on the curing time of PDMS at 100° C.; and

FIG. 4 shows the effect of curing inhibitor TEMPO on the curing time of PDMS with or without addition of barite and salt at 100° C.

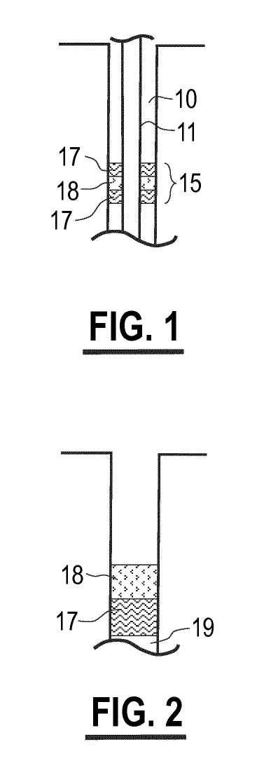

The drawings in FIGS. 1 and 2 are schematic illustrations, and not to scale. The drawings are for illustration purposes only, and not limiting the invention. Similar reference numerals in different figures denote the same or similar objects. Objects and other features depicted in the figures and/or described in this specification, abstract and/or claims may be combined in different ways by a person skilled in the art.

### DETAILED DESCRIPTION OF THE DEPICTED EMBODIMENTS

It is proposed to create a stacked cement and cured resin column within the wellbore, which provides a zonal isolation seal within the wellbore. To this end, slugs of a cement slurry and of a (heat curable) resin composition are injected into an underground wellbore. The resin composition contains at least a curable resin, a filler, a swelling agent, a curing initiator (for instance, a peroxide curing initiator or, more specifically, an organic peroxide curing initiator), and a crosslinking retarding agent (suitably a nitroxide crosslinking retarding agent). The crosslinking retarding agent delays curing of the resin, to permit pumping the composition into the wellbore. After injection, the cement slurry and resin composition are allowed to cure, to form the stacked column.

The present proposal employs an initiated cross linking resin system, that can advantageously be pumped as part of the cement job. The resin can be pumped as a tail slurry, lead slurry, or both. This way the structural functionality, provided by the cement, is decoupled from the sealing functionality that is provided by the cured resin composition, which contains a swelling agent. The cured resin is preferably swellable by allowing contact with a wellbore fluid, such as hydrocarbon oil, produced water, water from the gas phase, or preferably a combination of two of or all three of the fluids. Herewith the sealing function is further facilitated.

The resin composition may suitably be an elastomer-forming composition. The resin composition may form, after curing, an elastomeric element above and/or below the cement column and may act in way similar to a water and/or oil swell packer. However, in the present proposal, the ‘swell packer’ is pumpable and thus does not have an impact on the running clearance of well tubulars.

The combination of Portland based cement systems as construction material with a pumpable swell packer as extra sealing element dramatically enhances zonal isolation in well construction. Rheology and kinetics of the cross-linking reaction of the still liquid system can be fully controlled to match the properties of traditional oil well cements.

The curable resin may suitably comprise a siloxane fluid, which cures into a silicone rubber. Due to the flexibility of silicone rubber, the material is not as brittle and the formation of micro-annuli is much less likely. The addition of the inhibitor will allow enough time for the mixture to be pumped into place, the fillers will provide the appropriate density and the swell component will allow the rubber to swell. Overall a curing retarded polymer mixture has significant potential to provide a better gas tight seal than the zonal isolation materials that are currently used.

It has been proposed in the past to replace a cement seal by an addition-cured silicone composition, as disclosed in U.S. Pat. No. 6,196,316. It was found that the Pt-catalysts used for addition curing in this known method were sensitive to certain elastomers and metal surfaces that could be encountered during placement in oil and/or gas wells. The Pt-catalyst may at least be partially ineffective as a result of by side reactions with elastomers and metal surface, and would result in non or partially cured silicone.

The current invention addresses these, and possibly other, issues by using a resin composition of which the cross linking reaction is initiated with a curing initiator. The curing initiator may suitably comprise one or more peroxides or other radial-releasing substances. Herewith a reaction is initiated by radicals to cross link the curable resin (rather than cross-linking by an addition reaction). The resulting reaction may be a condensation reaction initiated with the curing initiator (e.g. peroxides).

The resulting product has in general improved mechanical and structural properties.

Additionally there is a large range of curing initiators (such as peroxides) available for a large temperature range to control the cure kinetics. This makes the method quite versatile to be used in a variety of wells and at a variety of depths, as a large range of curing temperatures is available by selecting the right peroxides. The curing initiator may comprise a range of curing initiators, each having a different decomposition temperature.

The curing initiator is suitably a radical initiator. Such radical initiator decomposes when heated, and thereby generates reactive radicals that initiate the curing, for instance by initiating a cross-linking reaction. The cross-linking reaction may be a condensation reaction.

The curing is initiated when the curing initiators are decomposed into radicals under influence of temperature. The resin composition is therefore a heat curable resin, as the curing initiators require heat at an elevated temperature to decompose. The rate at which the radicals are released is governed by temperature.

At least part of the released radicals may be absorbed by the crosslinking retarding agent, to delay the curing of the resin. Suitably, the cross linking retarding agent is a nitroxide cross linking retarding agent. Alternative radical absorbing cross linking retarding agents may optionally be contemplated in addition of nitroxides or instead of nitroxides.

Of the peroxide curing initiators, organic peroxides have shown to be specifically suitable. Optionally, wherein an ambient elevated downhole temperature in the wellbore is between 20 and 150° C. and the (organic) peroxide curing initiator comprises one or more peroxides known as TMCH, BCHPC and/or DCBP, which release radicals at different ranges of elevated temperatures between 20 and 150° C. or between 30 and 150° C.

In one specific group of embodiments, the method comprises:
injecting into the wellbore slugs of a cement slurry;
in addition injecting into the wellbore slugs of a heat curable resin composition comprising a curable resin, a filler, a swelling agent, an organic peroxide curing initiator and a nitroxide crosslinking retarding agent, which delays curing of the resin to permit pumping the composition into the wellbore; and
allowing the cement slurry and heat curable resin composition to cure to create a stacked cement and resin column that provides a zonal isolation seal within the wellbore. The stacked cement and resin column may comprise alternating layers of cement and resin.

The invention generally provides an improved downhole zonal isolation method that can be used during and after drilling operations, utilizing a further improved downhole polymer sealing material with significant flexibility, durability and strength that can be pumped into the wellbore without premature curing.

Optionally, as illustrated in FIG. 1, the slugs may be injected into an annular space 10 surrounding a wellbore tubular 11, to create a stacked annular cement and resin column 15 within said annular space 10. In the present column 15, the cured resin 18 is sandwiched between two layers of cement 17. However, this is only one of the available options. The wellbore tubular may, for instance, be a well casing or liner.

Alternatively, as illustrated in FIG. 2, the slugs may be injected into the wellbore or a wellbore tubular to seal off at least a lower part 19 of the wellbore or wellbore tubular. In this example, the cured resin layer 18 is on top of the cement layer 17. The wellbore may be an abandoned oil and/or gas production well.

In either case, the method may include a step of swelling the cured resin, suitably by allowing contact with a wellbore fluid.

The invention also provides an improved zonal isolation system that will maintain its swellable/self-healing properties for the life time of the well.

The invention also provides improved curing retarded elastomers like silicone rubber compositions to seal annuli and solve other downhole zonal isolation problems, which can be pumped into a well without the risk of premature curing or scorching. Elastomers are excellent sealing materials that can withstand pressure and temperature fluctuations without loss of hydraulic seal. Additionally the swell capabilities both with oil and water, water from the gas phase and brines results in a materials with self-healing properties. Although some cement systems can expand during cure they don't have expansion properties after a prolonged period of time, for example a period of several weeks.

The curable resin may comprise polydimethylsiloxane (PDMS), polymethylhydrosiloxane (PHMS).

The nitroxide crosslinking retarding agent may comprise 2,2,6,6-Tetramethylpiperdinyloxyl(C19H18NO) known as TEMPO and/or 4-Acryloyoxy-2,2,6,6-tetramethylpiperdine-N-oxyl, known as AOTEMPO and the nitroxide crosslinking retarding agent may be configured to absorb at least part of the released radicals and thereby delay curing of the resin during at least one hour and the organic peroxide curing initiator/nitroxide crosslinking retarding agent mol-ratio may be less than 1. In special cases, the organic peroxide curing initiator/nitroxide crosslinking retarding agent molar ratio may be between 0.1 and 0.81 and configured to absorb at least part of the released radicals and thereby delay curing of the resin during a period of 1 to 5 hours.

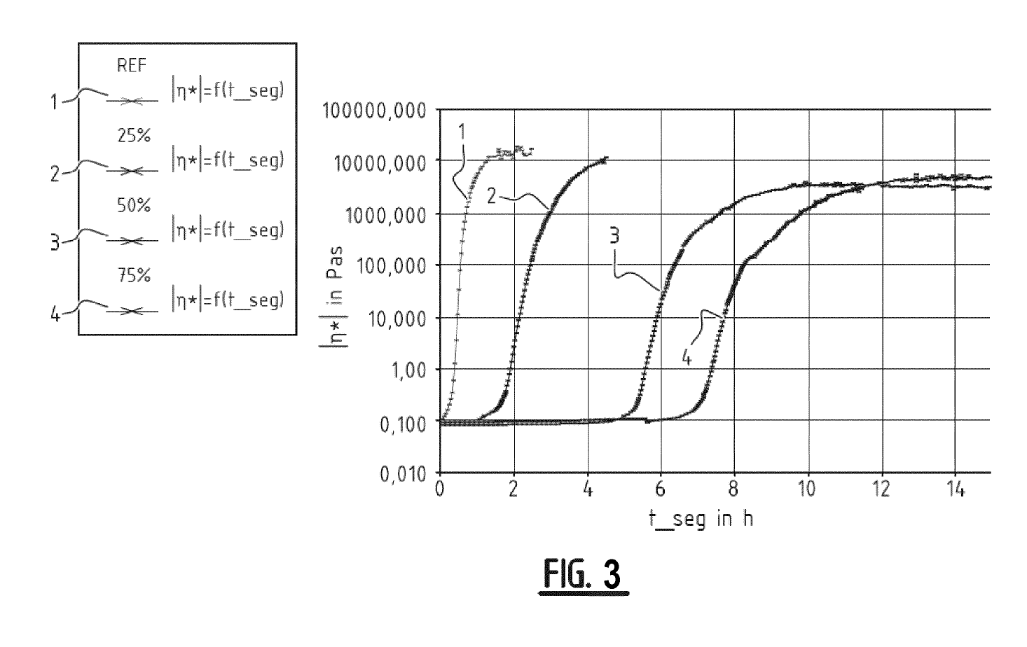

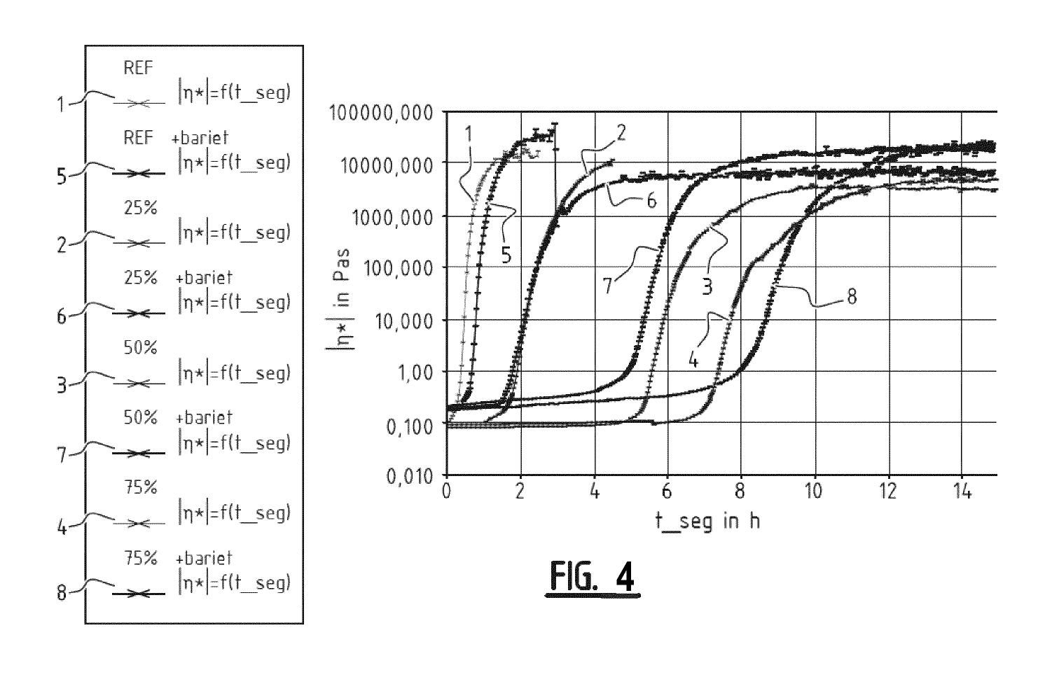

Various experiments that are described in more detail below were carried out to find a way to delay radical initiated polydimethylsiloxane (PDMS), Polymethylhydrosiloxane (PMHS) and other polymer crosslinking, whilst obtaining a material that meets the requirements needed for use in this application. This delay is required to enable pumping and placement of the liquid polymer mixture before it becomes solid. The effect of 2,2,6,6-tetramethylpiperidinyloxyl (TEMPO nitroxide) on the curing of PDMS was examined. The experiments described in more detail below and of which results are illustrated in FIGS. 3 and 4 show that TEMPO delays the crosslinking reaction of PDMS using a number of peroxides with different decomposition temperatures. As a result a temperature range of 40° C. to 100° C. can be covered. The reaction mixtures have a low viscosity for several hours before the crosslinking reaction occurs. In actual well conditions barite and salt can be added to the silicone mixture. Addition of barite and salt has no significant influence on the effect of TEMPO. At a certain concentration, depending on the peroxide and the temperature used, TEMPO will have a significant effect on the crosslink density of the final product.

Alternatively, the curable resin may comprise vinylneodecanoate and/or poly(vinylneodecanoate). TEMPO can also delay the polymerization of vinylneodecanoate.

The aim of this invention is to provide a polymer that can be pumped into a drilled or abandoned well with a catalyst that automatically initiates the polymerization downhole after several hours.

An ideal polymerization would have the following kinetic properties: the reaction mixture is mixed at room temperature for one hour, then during pumping and placement it would have a low viscosity for approximately eight hours. The temperature in the wellbore can vary between 20° C. to 120° C. After pumping and placement it would take three hours for the polymer to be fully hardened. The polymer material should generally have the following properties: a viscosity of maximum 1500 mPa·s at 20° C. and a density of 1000 kg/m3 up to 3000 kg/m3. Furthermore, it requires a certain flexibility. It needs to have an elongation before break of minimum 50% but also must be able to withstand an absolute pressure up to 1000 bar. The final product should be resistant to water, seawater and hydrocarbons.

For such application it is desired to have a delayed polymerization where the mixture could be pumped for several hours before polymer curing occurs. Polymer curing may be accomplished by reactive radical polymerization, which is a chain process involving several steps. First active centers are formed, either catalytically or by thermal activation. These active centers are formed when an initiator, for example the peroxide, decomposes into free radicals (r.). The radicals can react with double (or triple) bonds or can undergo hydrogen abstraction to form a carbon-centered radical R.. Polymer chains are formed by the successive addition of monomer molecules (M) to the radicals. In chain transfer the active site is transferred to a monomer or solvent molecule, initiating the growth of a new chain.

Chain termination can occur by combination. This is when a growing chain combines with another growing chain or radical. Termination can also occur by disproportionation. In case of disproportionation a free radical removes a hydrogen from an active chain. A carbon-carbon double bond is formed and the polymerization reaction stops. Disproportionation can also occur when the radical reacts with an impurity.

During the pumping and placement of the reaction mixture into the wellbore, the temperature will rise 1° C. every 40 meters deeper into the ground. The peroxide could partially decompose, causing premature crosslinking, or scorching. Scorching can be prevented by selecting a suitable initiator. Different types of initiators are used for radical polymerization. Oxygen and carbon centered radicals are often used due to their reactivity, thus organic peroxides and azo compounds are common initiators. An important characteristic of an initiator for a polymerization is its rate of decomposition at a certain temperature expressed by its half-life (t ½). The relation between the temperature and the rate of decomposition of an initiator may be expressed by an Arrhenius equation.

Another way to prevent scorch is by using an inhibitor. Inhibitors are widely used as radical scavengers to prevent polymerization during monomer storage. Inhibitors convert initiating and propagating radicals to non-radical species or radicals with low reactivity. Strong inhibitors react with every radical they encounter. The chain no longer propagates until the inhibitor is consumed. Weak inhibitors (retarders) on the other hand react with a portion of the radicals. The inhibitor can terminate the reaction when a radical abstracts a hydrogen atom from the inhibitor molecule. The inhibitor radical that is formed is less reactive. The inhibitor can also quench the propagation by adding to the chain to form a relatively stable species. Different types of inhibitors are available for the inhibition or retardation of radical polymerization.

A common inhibitor that can add to a growing chain is oxygen. When a growing chain reacts with molecular oxygen, a much less reactive peroxyl radical (RO2.) is formed.

Antioxidants are commonly used as curing inhibitors. Addition of the antioxidant terminates the propagating chain by forming highly resonance stabilized tertiary radicals that have very limited reactivity. Phenol- and amine-type inhibitors work best in the presence of oxygen. They react with the peroxyl radicals and stop chain propagation. In a wellbore little to no molecular oxygen is present, which makes this type of inhibitor less suitable for downhole application. Another downside of using antioxidants for scorch control is that there is a loss in crosslink density because of the radical quenching of the polymer radicals as well as the initiator radicals.

Simple peroxide cures are essentially stoichiometric reactions that yield at most one crosslink per molecule of initiator. Crosslinking occurs only when two polymer radicals combine. The quenching effect on polymer radicals can therefore have a large effect on crosslink density.

Known methods for minimizing scorch and otherwise controlling the curing of silicone and other polymer compositions are disclosed in U.S. Pat. Nos. 7,226,964; 7,262,250; 7,465,769; 7,829,634; 8,735,475; and US patent application publication US 2015/0060312.

Because of the properties of silicone rubber, it is a promising material for downhole application. Silicone rubber is a generic term used for a group of polymers with a backbone consisting of a silicone/oxygen chain. The silicone can be bonded to different side groups. The most common silicone rubber is polydimethylsiloxane (PDMS) and Polymethylhydrosiloxane (PMHS) where the silicone is bonded to two methyl substituents or one methyl and one hydrogen. PDMS rubber has relatively high temperature resistance, high chemical resistance, and good mechanical properties. PDMS chains are very flexible. This is because the polymer backbone consists of Si—O bonds. There is less strain on Si—O bonds compared to a C—C bond because of the larger length of the bond and a larger bond angle.

The linear silicone polymer chains can be crosslinked to create a three dimensional elastic network (a rubber). The substituents that are bonded to the silicone can have an effect on the properties of the rubber. For example if peroxides are used for the crosslinking of the silicone chains, the presence of some vinyl substituents (less than 1%) can increase the crosslinking efficiency. The resulting material will be more resistant to hot oil compared to PDMS without vinyl substituents. Silicone rubber acts as an elastomer. This means that when relatively low forced are applied, the material can be largely deformed. When the force is released, it returns to its original shape. Although the rubber is elastic, it is not compressible. Silicone rubber in general has a very high chemical and thermal stability. The high stability is due to the strong bonds in the silicone chains. The silicone oxygen bonds are stronger than the bonds of other polymers like ethylene propylene rubber or epoxy. This property gives silicone rubber its stability against heat and UV radiation.

The long polymer chains in linear PDMS and PHMS can be crosslinked using organic peroxides. The peroxide radicals can react with polymer chains. This will generate polymer radicals. These polymer radicals can combine to form carbon-carbon bonds. The combination of the chains is an exothermic and irreversible reaction. The linear polymer chains combine to create a three dimensional elastic network. Some peroxides, dicumylperoxide for example, are vinyl specific. This means they can only crosslink vinyl groups. Other peroxides, for example benzoylperoxide, can crosslink both methyl and vinyl groups. This difference is proven by Dluzneski to be caused by the inability of alkoxy radicals to abstract a hydrogen from a methyl of the PDMS for thermodynamic reasons. The peroxide adds to the double bond, thereby generating polymer radicals.

Another possible alternative for cement could be poly(vinylneodecanoate). Poly(vinylneodecanoate) offers advantages compared to silicone rubber. The thermal stability of poly(vinylneodecanoate) is much higher than crosslinked silicone, which becomes unstable at temperatures higher than 120° C. in the presence of water. A downside of using poly(vinylneodecanoate) is that the polymerization reaction is exothermal. After the reaction is complete, the product will cool down and shrink. The shrinkage can cause ruptures in the final product and a loss in isolation efficiency.

During a crosslinking or polymerization reaction the viscosity can be used a measure of the degree of polymerization. Viscosity of a fluid is a measure of its resistance to gradual deformation by shear stress or tensile stress. The shear resistance in a fluid is caused by the friction between molecules when layers of fluid attempt to slide by one another. Dynamic (or absolute) viscosity is a measure of internal resistance. The dynamic viscosity is measured by two horizontal plates that are placed at a given distance in a fluid. The plates are moved with respect to another at a unit velocity. Kinematic viscosity is the ratio of dynamic viscosity to density. Kinematic viscosity can be obtained by dividing the absolute viscosity of a fluid with the fluid mass density. The viscosity of a fluid is highly temperature dependent. It decreases with higher temperature. During a polymerization the degree of polymerization can be calculated from intrinsic viscosity measurements. For most polymerizations the Mark-Houwink equation gives the relationship between molecular weight (degree of polymerization) and viscosity.

An ideal situation for this application would be to be able to control the polymerization or crosslinking reaction in such a way that the reaction mixture would have a low viscosity for several hours before the reaction proceeds and the mixture is cured. An unwanted scenario is for the retarder to delay the entire cure, leaving a limited amount of time for the mixture to be pumped into place, whilst delaying the total curing time. The time in which inhibitors and retarders are reacted away is called the induction period. In a typical polymerization the initial rate of monomer conversion is high. It gradually slows down until high conversions are reached. If a retarder is present, it will react with some of the initiator causing a lower initial monomer conversion. When the retarder is consumed, the conversion will increase to a high rate and then gradually decrease. If a strong inhibitor is present it will react with every radical it encounters. Therefore, the initial reaction rate will be very low. Only when a significant amount of inhibitor has been consumed, the reaction rate will increase. Due to the loss of initiator at the start of the reaction the polymerization will proceed quite slowly.

When silicone rubber is used in a borehole for zonal isolation it is possible to pump batches of the silicone mixture alternatingly with cement slurry in certain “layers”. For a certain part of the annulus, the top would be filled with cement, the middle part is filled with the silicone mixture and the bottom part is filled with cement to keep the silicone “plug” in place. The density of PDMS is approximately 1.05 g/cm³. The cement that is usually used in a borehole has a density of approximately 1.9 g/cm³. Because the cement slurry has a higher density than the silicone mixture, buoyancy effects can cause the cement to mix in with the silicone. This causes a loss in isolation efficiency of the silicone rubber. Pumping a lower density mixture into the borehole has another well control disadvantage. Deeper into the ground, the formations can be porous. These pores can contain for example oil or gas. These pores have a certain pore pressure. If the local pressure outside of the pores is lower than inside the pores, liquid or gas will flow out from the formation and into the silicone mixture. To prevent these things from happening certain additives, or “fillers” can be used to increase the density of the silicone rubber, for example barite.

Salt can be added to the silicone mixture as a swell component. If the silicone rubber contains salt (in higher concentration than outside of the rubber) it will absorb water, causing the rubber to swell. This has a positive effect on the isolation efficiency of the rubber.

The present description thus proposes a downhole polymer sealing material with significant flexibility, durability and strength for downhole applications during and after drilling operations, that can be pumped into the wellbore without premature curing.

### EXAMPLES

Polydimethylsiloxane (PDMS, viscosity 200 mPa·s) and polydimethylsiloxane (PDMS, SLM61211 A, FS0212/19) from Wacker Silicones were used. The PDMS mixtures contain functional groups and additives for crosslinking. Poly(methylhydrosiloxane) (PMHS, CAS 63148-57-2) from Alfa Aesar GmbH & Co. was used as an accelerator. Polyglycol from Wacker Silicones (Wacker Stabilizer 43) was used as a stabilizer. Barite (85-90% barium sulphate, 4-6% crystalline silica and trace levels (<0,1%) potential carcinogen) from Baker Hughes Drilling Fluids was used as a filler to increase the density. Sodium chloride (NaCl, 100% w/w) from AkzoNobel was used as a swell-component. 1,1-di-(tertbutylperoxy)-3,3,5-trimethylcyclohexane (TMCH, pure) from United Initiators was used as an initiator. Bis(4-tertbutylcyclohexyl)-peroxydicarbonate (BCHPC, pure) from United Initiators was used as an initiator. Bis(2,4-dichloorbenzoyl)peroxide (Luperox DCBP, 50%) from Arkema B.V. was used as an initiator. The nitroxide 2,2,6,6-tetramethyl-1-piperidinyloxy (TEMPO, 98%) from Sigma-Aldrich [24] was used as a retarder. Vinylneodecanoate (>50%) from Kraton Polymers Research and Development (KIC-14-095) was used.

For the crosslinking reaction of PDMS a Haake Mars III rheometer from Thermo Scientific was used with aluminium disposable plate-plate measuring equipment. The gap between the plates was set to 0.5 mm (a sample volume of 1.45 mL). A temperature program was used. In the first step the plate was rotated in 260 seconds from 5 to 1000 rotations per second. Then the plates were heated and kept on the set temperature. Another rotation step of 260 sec from 5 to 1000 rotations per second followed. Then an oscillation step in which the top plate was oscillated at 1 Hertz with a force of 3 Pascal for a maximum of 25 hours, during which the apparent viscosity was measured. A cap with nitrogen flow was used to cover the plates during the experiment.

For the polymerization of vinylneodecanoate a Thermal M Oil Bath Liquid from Grant was used. The temperature during the reaction was monitored using temperature probes and software from Pico Technology.

For optimal results the PDMS (optionally with stabilizer 43 and/or PMHS) was mixed with TEMPO until the TEMPO was fully dissolved. Then an initiator was added and mixed until fully dissolved. Optionally barite and salt were added and mixed in the final step. The samples were placed in the rheometer. When using vinylneodecanoate, the vinylneodecanoate was mixed with TEMPO, subsequently the peroxide was added. A temperature probe was inserted and the samples were placed in an oil bath.

PDMS can be cured at 80° C. using TMCH as initiator. To study the effect of TEMPO nitroxide on the curing time of PDMS, PDMS was cured at 100° C. using TMCH as initiator with different concentrations of TEMPO added to the reaction mixture.

In FIG. 3 the results and mix ratios used are depicted. The results shown by curves 1-4 indicate that the curing time increases as the concentration of TEMPO increases. At the highest concentration of TEMPO (75%, ie. 75 mol TEMPO/mol TMCH*100), the reaction mixture has a low viscosity for approximately 7 hours before the crosslinking reaction takes place.

To examine if TEMPO could be used as a retarder at a lower temperature range the silicone was cured using BCHPC as an initiator. This peroxide has a lower activation energy (Ea), and thus a higher rate of dissociation at lower temperature. PDMS can be cured at 40° C. using this BCHPC as initiator. These experiments were performed at 50° C. with addition of TEMPO. The results show that using TEMPO and BCHPC, the crosslinking reaction of PDMS can be controlled at temperatures up to 50° C. To see if this peroxide could also be used at higher temperatures, the experiments were repeated at 60° C.

The results of these experiments show that the crosslinking reaction can be delayed for up to approximately 4 hours. The final product of the reaction mixture that contains 15% TEMPO was a gel instead of a solid rubber. The results show that as the concentration of TEMPO increases, the value of the apparent viscosity of the final product decreases. This indicates that at higher temperatures, the concentration of TEMPO has a significant effect on the crosslink density of the final product. At het highest concentration of TEMPO (20%), the crosslinking reaction does not take place at all. Similar results were obtained at 70° C.

Previous results show that curing PDMS at 60° C. using BCHPC as initiator and by addition of TEMPO yields relatively short curing times or a final product with low crosslink density. DCBP was tested as initiator for the cure of PDMS at 60° C. At 60° C. the reaction mixture has a relatively low viscosity for up to 8 hours before the crosslinking reaction takes place. To see if DCBP could be used in combination with TEMPO to cover a temperature range up to 70° C. different concentrations of TEMPO were added at various mix ratios. The results show that by addition of TEMPO the cure at 70° C. can be delayed for up to 5 hours.

In further experiments barite and salt were added in the last mixing step to see if this would influence the effect of TEMPO on the curing time of PDMS.

In FIG. 4 these results, illustrated by curves 5-8, are compared with the results, illustrated by curves 1-4 without the addition of barite and salt, noting that curves 1-4 are shown both in FIG. 3 and in FIG. 4. The compared results illustrated by curves 1-4 and 5-8 show no significant difference.

To make the use of TEMPO for this application easier it would help if the final product would be a two-component mixture that could be mixed on site, or a 1 barrel system that could directly be pumped. To test the stability of TEMPO in silicone over time, 25% ([mol TEMPO]/[mol TMCH]*100) TEMPO was mixed with the PDMS and stored in a dark room at room temperature. The peroxide was added just before the mixtures were tested. The results show that TEMPO mixed with silicone and stored at room temperature for up to 3 weeks has no significant influence on the effect of TEMPO on the curing time of PDMS.

Another possible alternative for cement could be poly(vinylneodecanoate). To see if TEMPO could also be used in to delay the polymerization of vinylneodecanoate, the effect of TEMPO on de curing time of poly(vinylneodecanoate) was examined. The results with various mix ratios show that as the concentration of TEMPO increases, the peak of the exotherm shifts to the right. The polymerization is delayed for up to 38 hours. The final products were all solid poly(vinylneodecanoate).

The goal of these experiments was to find a way to delay or “control” a radical polymerization in such a way that the reaction mixture would have a low viscosity for several hours before the curing takes place. TEMPO nitroxide was examined as a retarder for the radical crosslinking of PDMS. The results show that TEMPO delays the crosslinking reaction of PDMS with TMCH, BCHPC or DCBP as initiator. The reaction mixtures have a low viscosity for several hours before the crosslinking reaction occurs. By using different peroxides in combination with TEMPO a temperature range can be covered from 40° C. up to 100° C.

When a peroxide with a relatively low activation energy in used at higher temperatures, the addition of high concentrations of TEMPO has a significant effect on the crosslink density of the final product. Also, when a certain concentration of TEMPO is exceeded, the reaction will not take place at all. This is probably because the peroxide decomposes very quickly at high temperatures. Because the reaction of the peroxide radicals with TEMPO radicals is fast compared to the crosslinking reaction, the peroxide radicals are readily trapped by the high concentration of stable radicals in the reaction mixture. This concentration depends on the type of peroxide used and the temperature at which the reaction takes place.

The experiments and FIG. 4 show that addition of barite and salt has no significant effect on the effect of TEMPO on the curing time. TEMPO seems to be stable in silicone. It can be mixed at the desired concentration and kept at room temperature in a dark room for up to 3 weeks. The fact that TEMPO would not have to be stored in a refrigerator and be mixed on site would make the implementation of a silicone mixture containing TEMPO in current drilling operations much easier. For mixtures containing a peroxide with a high Ea it might even be possible to mix the TEMPO and peroxide to the desired concentrations in one barrel. If these barrels are provided with a perishable date, these mixtures could be stored on site and directly pumped.

The effect of TEMPO on the polymerization of vinylneodecanoate was also evaluated. The polymerization at 80° C. can be delayed for up to 39 hours.

The results show that higher concentrations of TEMPO can have a negative effect on the crosslink density. Also, other nitroxides, such as 4-Acryloyloxy-2,2,6,6-tetramethylpiperidine-N-oxyl (AOTEMPO) could be further examined to see if these offer any advantages compared to TEMPO. They might have less effect on the crosslink density of the final product.

The experiments confirmed that a polymeric mixture comprising a curable resin, initiator, scorch-inhibitor, filler and swell-component that can be used as an alternative for cementing a wellbore.

The experiments furthermore demonstrated that premature crosslinking/scorching can be adequately prevented by using a nitroxide in a mixture comprising of a curable resin (for example polydimethylsiloxane), an organic peroxide initiator, a filler to increase the density and a swell component (for example salt). This mixture can be used as zonal isolation material in a wellbore.

If silicone is used, the polymeric mixture must be pumped into place. During pumping and placement of the mixture deeper into the ground the temperature will rise. This temperature rise can cause premature crosslinking or “scorching”. To prevent scorch the polymeric mixture contains 2,2,6,6-Tetramethylpiperidin-1-yl)oxyl (TEMPO nitroxide). This inhibitor can delay the cure for several hours so the mixture can be pumped into place.

As illustrated in FIG. 4 the polymer may also contain a filler to increase the density without significant impact on the curing delay and performance. If silicone rubber is used in a borehole for zonal isolation slugs of the density increased and curing retarded silicone mixture may be pumped alternatingly with slugs of cement to generate alternating sealing “layers”. For a certain part of the annulus or well interior, an upper part may be filled with cement, a middle part may be filled with the silicone mixture and a bottom part may be filled with cement to keep the silicone “plug” in place. The density of PDMS is approximately 1.05 g/cm³. The cement that is usually used in a borehole has a density of approximately 1.9 g/cm³. Because the cement mixture has a higher density than the silicone mixture, buoyancy effects can cause the cement to mix in with the silicone. This causes a loss in isolation efficiency of the silicone rubber. Pumping a lower density mixture into the borehole has another well control disadvantage. Deeper into the ground, the formations can be porous. These pores can contain for example oil or gas. These pores have a certain pore pressure. If the local pressure outside of the pores is lower than inside the pores, liquid or gas will flow out from the formation and into the silicone mixture. To prevent these things from happening known fillers, such as barite, can be used to increase the density of the silicone mixture.

Salt can be added to the silicone mixture as a swell component. If the silicone rubber contains salt (in higher concentration than outside of the rubber) it will absorb water, causing the rubber to swell. This has a positive effect on the isolation efficiency of the rubber.

The sealing properties of the curing delayed polymer according to the invention were tested in a 2 meter high concentric set-up with an outer-tube (ID of 30 cm) and an inner tube (O.D. of 24.5 cm) standard class-g oil well cement was pumped in the annular space to a high of 60 cm. Subsequently the TEMPO retarded PDMS self-healing Silicone slurry according to the invention was pumped into the annulus displacing the cement to the top of the annulus. The set-up was closed and pressurized with nitrogen to 80 bars. The whole set-up was put in an oven at 80° C. Both the cement and the silicone slurry were allowed to cure for several days. Subsequently a differential pressure test was done to measure the sealing properties of the combined annular seal. Differential pressure was increased from 0.2 bars to 80 bars in several 2 hour long incremental steps. No gas leakage was observed through the whole test. This in contrast to a test with just class-g in which even the smallest differential pressure (0.2 bars) immediately results in substantial gas leakage.

Therefore, the method, system and/or any products according to present invention are well adapted to attain the ends and advantages mentioned as well as those that are inherent therein.

In most of the specific embodiments disclosed herein one or more organic peroxides were employed as curing initiator. Such peroxides or organic peroxides may be supplemented by or replaced by other curing initiators that can release reactive radicals. Examples include azo-compounds or organic azo-compounds. A specific example is azo-benzene. Peroxides may be preferable for reasons of minimizing chemical hazard risks.

The particular embodiments disclosed above are illustrative only, as the present invention may be modified, combined and/or practiced in different but equivalent manners apparent to those skilled in the art having the benefit of the teachings herein.

Furthermore, no limitations are intended to the details of construction or design herein shown, other than as described in the claims below.

It is therefore evident that the particular illustrative embodiments disclosed above may be altered, combined and/or modified and all such variations are considered within the scope of the present invention as defined in the accompanying claims.

While any methods, systems and/or products embodying the invention are described in terms of “comprising,” “containing,” or “including” various described features and/or steps, they can also “consist essentially of” or “consist of” the various described features and steps.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Also, the terms in the claims have their plain, ordinary meaning unless otherwise explicitly and clearly defined by the patentee.

Moreover, the indefinite articles “a” or “an”, as used in the claims, are defined herein to mean one or more than one of the element that it introduces.

If there is any conflict in the usages of a word or term in this specification and one or more patent or other documents that may be cited herein by reference, the definitions that are consistent with this specification should be adopted.

When used in this specification and claims the following abbreviations have the following meanings:

TMCH=1,1-Di-(tert.butylperoxy)-3,3,5-trimethylcyclohexane;

DCBP=1,1-Di-(tert.butylperoxy)-3,3,5-trimethylcyclohexane;

BCHPC=Bis(4-tertbutylcyclohexyl)-peroxydicarbonate.

1. A method for providing zonal isolation in an underground wellbore, the method comprising creating a stacked cement and cured resin column that provides a zonal isolation seal within the wellbore employing steps of:
injecting into the wellbore at least one slug of a cement slurry;
in addition to said injecting into the wellbore the at least one slug of a cement slurry, injecting into the wellbore at least one additional slug of a resin composition comprising a curable resin, a filler, a swelling agent, a curing initiator and a crosslinking retarding agent, which delays curing of the resin to permit pumping the composition into the wellbore;
creating a stacked cement and resin column by forming alternating layers of the at least one slug of the cement slurry and the at least one additional slug of the resin composition within the wellbore; and
allowing the cement slurry and resin composition in the stacked cement and resin column to cure.

2. The method of claim 1, wherein said cured resin is swellable upon contact with a wellbore fluid.

3. The method of claim 2, wherein the wellbore fluid is a hydrocarbon oil, or produced water, or water from the gas phase, or any combination thereof.

4. The method of claim 2, comprising, after the step of allowing the cement slurry and resin composition to cure, a step of swelling the cured resin.

5. The method of claim 1, wherein the resin composition is an elastomer-forming composition.

6. The method of claim 1, wherein the cured resin is a silicone rubber.

7. The method of claim 6, wherein the curable resin comprises at least one of the group consisting of: polydimethylsiloxane (PDMS) and polymethylhydrosiloxane (PHMS).

8. The method of claim 1, wherein the curable resin comprises at least one of the group consisting of: vinylneodecanoate and polyvinylneodecanoate.

9. The method of claim 1, wherein the curing initiator releases free radicals at an elevated temperature, and wherein curing of the resin comprises radical polymerization.

10. The method of claim 1, wherein curing of the resin is initiated when the curing initiator is decomposed into radicals.

11. The method of claim 10, wherein the curing initiator is decomposed into radicals under influence of temperature.

12. The method of claim 9, wherein the curing initiator comprises a range of radical releasing molecules, each having a different decomposition temperature.

13. The method of claim 9, wherein absorbing at least part of the released radicals with the crosslinking retarding agent, and thereby delaying curing of the resin.

14. The method of claim 1, wherein the curing initiator is a peroxide curing initiator.

15. The method of claim 14, wherein the peroxide curing initiator comprises an organic peroxide.

16. The method of claim 14, wherein an ambient elevated downhole temperature in the wellbore is between 20 and 150° C. and the peroxide curing initiator comprises at least one organic peroxide known from the group consisting of: TMCH, BCHPC and DCBP, which release radicals at different ranges of elevated temperatures between 20 and 150° C.

17. The method of claim 25, wherein the nitroxide crosslinking retarding agent comprises at least one of the group consisting, of 2,2,6,6-Tetramethylpiperdinyloxyl(C₁₉H₁₈NO) (known as TEMPO) and 4-Acryloyoxy-2,2,6,6-tetramethylpiperdine-N-oxyl (known as AOTEMPO).

18. The method of claim 25, wherein absorbing at least part of the released radicals with the nitroxide crosslinking retarding agent, and thereby delaying curing of the resin.

19. (canceled)

20. The method of claim 1, wherein the resin composition is a heat curable resin composition.

21. The method of claim 1, wherein the slugs are injected into an annular space surrounding a wellbore tubular to create a stacked annular cement and resin column within said annular space.

22. The method of claim 1, wherein the slugs are injected into the wellbore or a wellbore tubular, such as a well casing or liner, to seal off at least a lower part of the wellbore or wellbore tubular.

23. The method of claim 22, wherein the wellbore is an abandoned oil and/or gas production well.

24. The method of claim 1, wherein the cured resin is an elastomer.

25. The method of claim 14, wherein the crosslinking retarding agent is a nitroxide crosslinking retarding agent.
